(19) United States
(12) Patent Application Publication
(10) Pub. No.: US 2003/0142082 A1
(43) Pub. Date: Jul. 31, 2003

(54) Visually impaired screen enhancer

(75) Inventor: Fred L. Spalding, Portsmouth, VA (US)

Correspondence Address: RANDALL J. KNUTH P.C., 3510-A STELLHORN ROAD, FORT WAYNE, IN, 46815-4631, US

(73) Assignee: TOKHEIM CORPORATION

(21) Appl. No.: 10/060,638

(22) Filed: Jan. 30, 2002

(51) Int. Cl. G09G 5/00

(52) U.S. Cl. 345/175

(57) ABSTRACT

The present invention relates to a method and apparatus for enhancing a display on a fuel dispenser. The method includes providing a fuel dispenser with a display containing an image. The size of the image on the display can be enlarged. Also, the size of the image on the display can be reduced in size. Furthermore, the color of the image on the display can be changed.

### BACKGROUND OF THE INVENTION

1. Field of the Invention

The present invention relates to enlarging an image on a fuel dispenser display to enhance the image and accommodate visually impaired people.

2. Description of the Related Art

There is an on-going goal for businesses to accommodate visually impaired people. There are automated teller machines that provide audio guidance through speakers to explain how to operate the automated teller machine to a visually impaired person. Also, many industries use larger buttons on their products for easier use by people with visual impairments. One problem in the fuel dispensing industry, is that fuel dispensing displays can be difficult to read for a visually impaired person under different conditions. The image on the fuel dispenser display can be small and at times difficult to see. The present invention solves this problem.

### SUMMARY OF THE INVENTION

The invention, in one form thereof, is a display enhancing apparatus for a fuel dispenser. The apparatus includes a fuel dispenser having a display. The fuel dispenser has an enlarging means for selectably activating an enlargement of an image displayed on the fuel dispenser display. Also, a controller is connected to the fuel dispenser display and the enlarging means.

The invention, in another form thereof, comprises a method of enhancing a display for a fuel dispenser. The method begins with the step of providing a fuel dispenser with a display. The next step is displaying an image on the fuel dispenser display. The last step of the method is enlarging the size of the image on the fuel dispenser display.

The invention, in yet another form thereof, comprises a method of enhancing a display for a fuel dispenser. The method begins with the step of providing a fuel dispenser with a touch screen display. The next step of the method is displaying an image on the touch screen display. The last step of the method is touching the touch screen display which enlarges the image displayed on the fuel dispenser display.

An advantage of the present invention is that the image on the fuel dispenser display is now much easier to visualize for people who have a visual impairment or in environmental conditions such as direct sunlight.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a diagrammatic view of one form of the present invention;

FIG. 2 is a flowchart of one form of the present invention; and

FIG. 3 is a flowchart of another form of the present invention; and

FIG. 4 is a diagrammatic view of a fuel dispenser displaying a normal sized image on the fuel dispenser display; and

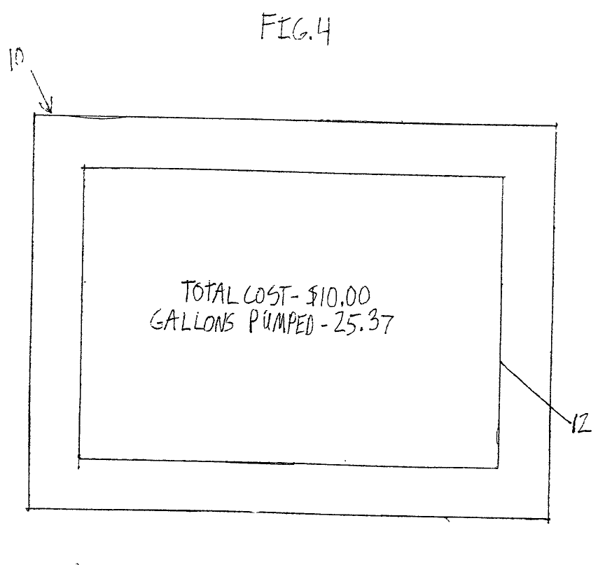

FIG. 5 is a diagrammatic view of a fuel dispenser displaying an enlarged size image on the fuel dispenser display.

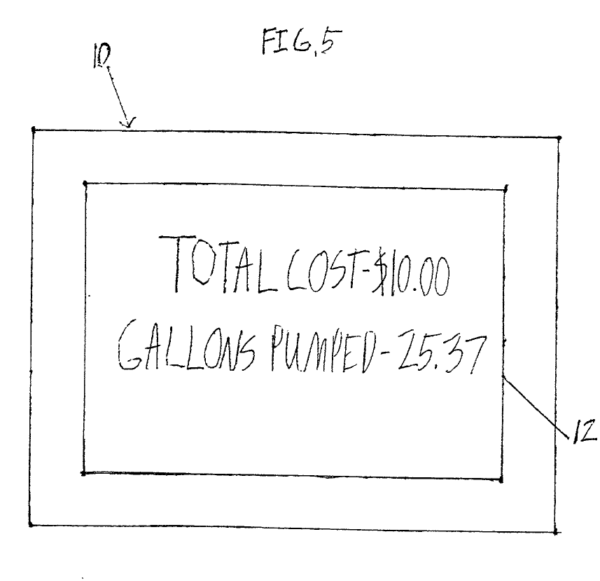

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

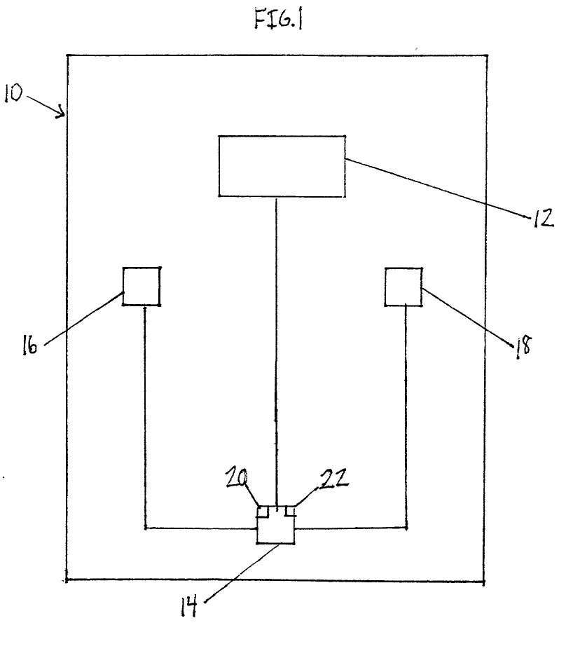

One embodiment of the present invention, as shown in FIG. 1 of the drawings, there is shown a display enhancing apparatus for fuel dispenser 10. Display 12 is located on fuel dispenser 10. Fuel dispenser 10 has a controller 14. Controller 14 is connected to display 12, an image enlarging means 16 and an image reducing means 18 using a connection device such as a cable. Other connection devices could be used to connect the various components.

Controller 14 has a memory 20 for storing images that are visually perceived as normal, larger than normal and smaller than normal. Some examples of the images stored in memory 20 would be the price of the different types of fuel dispensed from fuel dispenser 10, the total amount of gallons pumped for each customer utilizing fuel dispenser 10, the total cost of the gallons pumped for each customer utilizing fuel dispenser 10, as well as graphical images used in advertisements on the display of fuel dispenser 10. Controller 14 also has a computer program stored in memory 20 that allows for the images to be swapped (transferred) between the currently displayed image and the image desired by the customer. The computer program is written in JavaScript for easiest implementation, but other programming languages can be used. There are many examples of JavaScript code for image swapping located on the Internet. To locate these examples, enter the key words “swapping images” into an internet search engine and many examples will be found by the internet search engine. The preferred search engine to use to locate the most examples of swapping images is ASK.COM.

An example of swapping a visually larger image with a visually smaller image and vice versa is shown in the example below:

<html>
<head>
<script language=“JavaScript”><!--
function swap (target, source) {

if (document.images) {
document.images[target].src=document.images[source].src;
document.images[target].width=document.images[source].width;
document.images[target].height=document.images[source].height;
}

}
//==></script>
</head>
<body>
<img name=“large” src=“banner0002.gif”>
<img name=“small” src=“home0.gif”>
<form>
<input type=“button” value=“swap larger for smaller”
onClick=“swap(‘large’,‘small’)
<input type=“button” value=“swap smaller for larger”
onClick=“swap(‘small’,‘large’)
</form>
</body>
</html>

Upon activation of image enlarging means 16, a signal is sent to controller 14 and controller 14 swaps the currently displayed image with a visually larger image from memory 20 of controller 14. Upon activation of image reducing means 18, controller 14 receives a signal and swaps the currently displayed image with a visually smaller image from memory 20 area of controller 14.

Image enlarging means 16 and image reducing means 18 can be a touch screen sensor. Touching image enlarging means 16 sends a signal to controller 14 and controller 14 swaps the currently displayed image on display 12 with a visually larger image from memory 20 of controller 14. Touching image reducing means 18 sends a signal to controller 14 and controller 14 swaps the currently displayed image on display 12 with a visually reduced size image from memory 20 of controller 14.

Image enlarging means 16 and image reducing means 18 can be a switch, such as a button or an extending member. Other types of switches can be used as well. Image enlarging means 16 can be a button having an arrow pointing in the upward direction and image reducing means 18 can be a separate button having an arrow pointing in the downward direction. Image enlarging means 16 can be an extending member that is moved in the upward direction to enlarge the image on display 12 and when the extending member is moved in the downward direction, the image on display 12 is reduced. Both image enlarging means 16 and image reducing means 18 send a signal to controller 14 to swap the images based on which of image enlarging means 16 and image reducing means 18 are activated.

Another way of enlarging or reducing the visual appearance of the image on display 12 is to have a software program running on controller 14. Memory 20 of controller 14 is a grid of pixels. Memory 20 stores the color of each of the pixels displayed on display 12. In an example, which is not meant to be limiting, the background displayed on display 12 is white. To create a white background, each of the pixels in memory 20 would have the value representing white on display 12. This would make the entire display appear to be white. When it is decided to display an image on display 12, the software changes the values in memory 12 for each of the pixels needed to display the image so that the pixels are displayed as a color other than white. The background pixels or empty parts of the image continue to hold the value in memory 20 representing the color white on display 12.

When it is desired to give the appearance of enlarging the image on display 12, a process known as interpolation is used. Interpolation is a process where the software changes the values in memory 20 so that additional pixels are displayed as a different color than white on display 12. By changing the values of additional pixels so that the pixels are now displayed as a color other than white, the image on display 12 appears to be larger than normal. To reduce the appearance of the image on display 12, some pixels that have a value in memory 20 representing a particular color other than white, have their values changed by the software to now be displayed as white pixels on display 12. The additional white pixels and reduction of non-white colored pixels causes the image on display 12 to appear smaller than it previously appeared.

Upon pressing the top of image enlarging means 16, a signal is sent to controller 14 and controller 14 activates the software program to enlarge the image for the top portion of display 12 by changing the values of some of the white pixels and causing them to now be non-white colored pixels. Pressing the top of image enlarging means 16 again, causes controller 14 to activate the software program to cause even more of the white pixels to now have a non-white color and therefore causes the image to appear larger on display 12. After pressing the top of image enlarging means 16 a predetermined number of times, the software program will cause the image to appear as it originally appeared when the customer initiated the use of fuel dispenser 10. Pressing a direction other than the top of image enlarging means 16 works in exactly the same manner as when the top of image enlarging means 16 was pressed.

Another example of changing the appearance of the image on display 12 is to use a JavaScript program to change the size of the image. An example of zooming in and out on an image on display 12 is shown in the example below:

<INPUT ID=“zoomfactor” Type=“text” VALUE=“50” SIZE=“3” MAXLENGTH=“4”<DIV ID=“container”>

Have you read our columns about Print Templates?

</DIV>
<SCRIPT LANGUAGE=“JavaScript”>
<!--
Function updateZoom( ) {

container.style.zoom = zoomfactor.value + “%”;

}
//-->
</SCRIPT>

Based on the percentage of zoom desired, the image will either appear larger or smaller. After activating either image enlarging means 16 or image reducing means 18 a predetermined number of times, the original percentage of zoom will be displayed and the image will appear as it did when the customer initiated the use of fuel dispenser 10.

Image enlarging means 16 and image reducing means 18 can be one or more voice recognition devices. Upon receiving a voice command from a customer, the voice command is sent by either or both of image enlarging means 16 and image reducing means 18 to controller 14 and controller 14 compares the voice command to a list of acceptable voice commands stored in memory 20 of controller 14. Some examples of acceptable voice commands would be “enlarge” and “reduce”. If controller 14 finds a match between the voice command and the list of acceptable commands, controller 14 will either swap the image on display 12 with a visually larger image or a smaller image based on the voice command. If controller 14 does not find a match between the voice command and the list of acceptable commands, the voice command is ignored.

Image enlarging means 16 and image reducing means 18 can be utilized to enlarge or reduce the image displayed on display 12 by a predetermined percentage. The predetermined percentage is 20% but other percentages could be used. Utilizing a predetermined percentage of 20%, each time image enlarging means 16 is activated, controller 14 would swap the current image displayed on display 12 with an image from memory 20 of controller 14 that is 20% larger than the image currently displayed. The next time image enlarging means 16 is activated, controller 14 would swap the currently displayed image with an image 40% larger than that image displayed on display 12. The image on display 12 can be enlarged to a predetermined maximum percentage such as 200% of the images normal size. The 200% maximum percentage for the size of the image is for example purposes only and is not meant to be limiting to the invention. A larger or smaller maximum percentage for the image to be displayed on display 12 can be used as well. Image reducing means 18 would operate in the same manner as image enlarging means 16.

Image enlarging means 16 can also be utilized to change the colors of the image displayed on display 12. Upon activation of image enlarging means 16, a signal is sent to controller 14 and controller 14 swaps the currently displayed image on display 12 with an image utilizing different colors stored in memory 20 of controller 14. The different color or color combinations for images in memory 20 of controller 14 correspond to different degrees and types of color blindness for the customer using fuel dispenser 10. Each time image enlarging means 16 is activated, a new color or color combination of the image displayed on display 12 is presented to the customer using fuel dispenser 10.

As was described previously, fuel dispenser 10 can utilize image enlarging means 16 to not only change the size of the image on display 12 but to also change the color of the image on display 12. If image enlarging means 16 is a voice recognition device, then a command such as the word “color” would send a signal from image enlarging means 16 to controller 14 to swap the image for a different colored image to be displayed on display 12. If image enlarging means 16 is a touch screen sensor, a designated area is established and upon touching that designated area, a signal is sent from image enlarging means 16 to controller 14 to swap the current image with the same image but in a different color or combination of colors. If image enlarging means 16 is an extending member, the extending member will be moved left or right to send a signal to controller 14 to swap the color of the current image displayed on display 12 and moving the extending member up and down to enlarge or reduce the size of the image on display 12. If image enlarging means 16 is a button, by pressing the left or right side of the button, a signal is sent to controller 14 to swap the image displayed on display 12 with an image in a different color or combination of colors to display 12. If the button is pushed on the top or bottom portion, the image is swapped for a smaller or large image to be displayed on display 12. These examples of utilizing image enlarging means 16 to change the size and/or color of the image on display 12 is not limiting and other ways of utilizing image enlarging means 16 for these purposes can be utilized.

An option for each of the implementations of image enlarging means 16 and image reducing means 18 is to use a timer 22. Timer 22 could be located in controller 14 and upon the elapsing of a predetermined amount of time, the enlarged or reduced image would be swapped by controller 14 back to the original size of the image on display 12. This option applies to the size of the image and/or the color of the image as well.

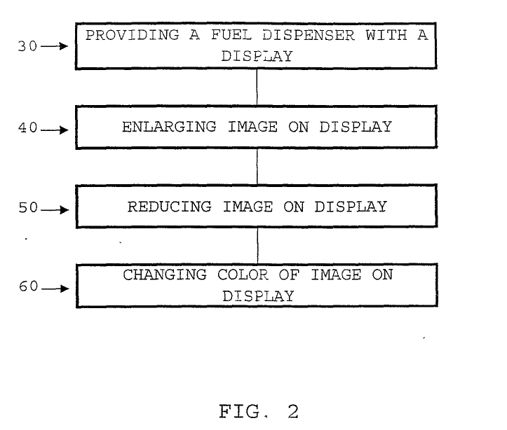

In another form of the present invention, there is a method of enhancing a display for a fuel dispenser. As shown in FIG. 2 of the drawings, the first step is providing a fuel dispenser with a display (30). The next step of the method is displaying an image on the fuel dispenser display (35). Another step of the method is enlarging the size of the image on the display (40). Enlarging the size of the image on the display (40) can be performed by activating a switch or a voice recognition device. The voice recognition device would be activated upon receiving a voice command and if that voice command matches a list of acceptable voice commands stored in the fuel dispenser, the size of the image on the display would be enlarged.

The switch can be a button or a lever. Other types of switches can be used as well. If the switch is a button, by pressing the button, the size of the image on the display would become enlarged (40). The button could also be multidirectional in which the button could be pressed at the top, bottom, left and right. Each direction of the button could correspond to a different image being displayed on the fuel dispenser display. In the case of the multidirectional button, pressing the top of the button would cause the size of the image on the display to become enlarged (40). If the switch is a lever, the movement of the lever in the upward direction would cause the image on the display to become enlarged (40) as well. The direction utilized to activate the switch is not meant to be limiting and touching the button in other directions as well as moving the lever in other directions could cause the size of the image on the display to become enlarged (40).

Another step of the method of enhancing the display is the reducing of the size of the image on the display (50). Reducing the size of the image on the display (50) could be performed using a switch, voice recognition device, or any other method can be used for causing the image on the display to be reduced (50). The reduction of the image utilizing a switch or voice recognition device would work in the same way as the enlarging of the size of the image on the display.

Another step of the method of enhancing a display on a fuel dispenser is to change the color of the image (60) on the fuel dispenser display. This step can be performed utilizing the same means as described for enlarging and/or reducing the size of the image on the fuel dispenser display. Also, a separate component on the fuel dispenser could be used for changing the color of the image (60) on the display of the fuel dispenser.

An option with the method of enhancing the display is to establish a predetermined amount of time and once the predetermined time has elapsed, the enlarged or reduced image will return to its original size and/or color. This is useful when the customer has finished using the fuel dispenser because the image on the fuel dispenser display will automatically swap to the original size and/or color of the image on the display for the next customer.

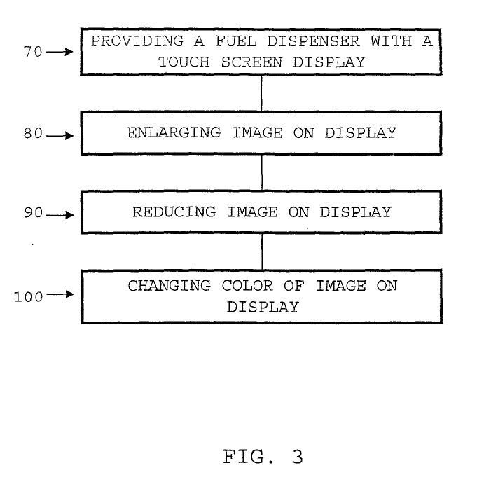

In another form of the present invention, as shown in FIG. 3, there is a method of enhancing a display for a fuel dispenser. The first step of the method is providing a fuel dispenser with a touch screen display (70). The touch screen display is divided into at least two sections. The next step of the method is displaying an image on the fuel dispenser display (75). Touching the touch screen display enlarges the image displayed on the fuel dispenser display (80).

There are different options for enhancing the display of the fuel dispenser. One option is that upon touching any of the at least two sections on the display causes the enlargement of the image on all sections of the display (80). Also, upon touching any of the at least two sections on the display a second time causes the reduction of the enlarged image on all sections of the display (90).

Another option would be to establish a predetermined section of the display to be touched to enlarge or reduce the image on the display (80). Once the predetermined section has been defined, touching the predetermined section of the display causes the enlargement of the image on all sections of the display (80). Also, touching the predetermined section a second time causes the reduction of the image on all sections of the display (90).

Another option is that by touching one of the at least two sections of the display causes enlargement of only the touched section of the display (80). Also, touching the same section a second time causes the reduction of the image on only that section of the display (90). The three options as described above are not limiting and any combination of the three options as well as other ways of enlarging and/or reducing the image by touching the display can be used.

Also, changing the color of the image on the display (100) can be utilized. The touch screen display can have a predetermined area and upon touching that predetermined area, would cause the changing of the color of the image on the display (100).

In addition to the options described above, once the image on the display is enlarged and/or the color changed, the elapsing of a predetermined amount of time causes the enlarged and/or different colored image to return back to its original size and/or color.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of enhancing a display for a fuel dispenser comprising:
providing a fuel dispenser with a touch screen display;
displaying an image on said touch screen display; and
touching said touch screen display to enlarge said image displayed on said display.

2. The method of enhancing a display of claim 1, wherein said touch screen display is divided into at least two sections.

3. The method of enhancing a display of claim 2, wherein touching any of the at least two sections enlarges the image.

4. The method of enhancing a display of claim 2, wherein touching one predetermined section of the at least two sections enlarges the image.

5. The method of enhancing a display of claim 2, wherein touching one of the at least two sections enlarges the image displayed on the touched section of said at least one section.

6. The method of enhancing a display of claim 3, wherein touching any of the at least two sections a second time reduces the enlarged image.

7. The method of enhancing a display of claim 4, wherein touching one predetermined section of the at least two sections a second time reduces the enlarged image.

8. The method of enhancing a display of claim 5, wherein touching one of the at least two sections a second time reduces the enlarged image.

9. The method of enhancing a display of claim 1, wherein elapsing of a predetermined amount of time causes the reduction of the enlarged image.

10. The method of enhancing a display of claim 3, wherein elapsing of a predetermined amount of time causes a reduction of the enlarged image.

11. The method of enhancing a display of claim 4, wherein elapsing of a predetermined amount of time causes a reduction of the enlarged image.

12. The method of enhancing a display of claim 5, wherein elapsing of a predetermined amount of time causes a reduction of the enlarged image.

13. The method of enhancing a display of claim 1, including the step of changing the color of the image.

14. A display enhancing apparatus for a fuel dispenser comprising:
a fuel dispenser having a display;
an image enlarging means connected to said fuel dispenser for activating the enlarging of an image displayed on said display; and
a controller connected to said display and said image enlarging means.

15. The display enhancing apparatus of claim 14, further comprising a image reducing means connected to said fuel dispenser for activating the reducing of the image displayed on said display, said image reducing means connected to said controller.

16. The display enhancing apparatus of claim 14, wherein said image enlarging means is a touchscreen sensor.

17. The display enhancing apparatus of claim 14, wherein said image enlarging means is a switch.

18. The display enhancing apparatus of claim 14, wherein said image enlarging means is a voice recognition device.

19. The display enhancing apparatus of claim 15, wherein said image reducing means is a touchscreen sensor.

20. The display enhancing apparatus of claim 15, wherein said image reducing means is a switch.

21. The display enhancing apparatus of claim 15, wherein said image reducing means is a voice recognition device.

22. The display enhancing apparatus of claim 14, wherein said image enlarging means enlarges the image by a predetermined percentage each time the image enlarging means is activated.

23. The display enhancing apparatus of claim 15, wherein said image reducing means reduces the image by a predetermined percentage each time the image reducing means is activated.

24. The display enhancing apparatus of claim 14, wherein said enlargement means activates changing the color of the image.

25. A method of enhancing a display for a fuel dispenser comprising:
providing a fuel dispenser with a display;
displaying an image on said display; and
enlarging the size of said image on said display.

26. The method of enhancing a display of claim 25, including the step of reducing the size of the image on said display.

27. The method of enhancing a display of claim 25, including the step of changing the color of the image on said display.

28. The method of enhancing a display of claim 25, wherein the elapsing of a predetermined amount of time causes a reduction in size of the enlarged image.
